(19) United States
(12) Patent Application Publication
(10) Pub. No.: US 2006/0079364 A1
(43) Pub. Date: Apr. 13, 2006

(54) Link chain

(76) Inventors: Paul Skljarow, Schwieberdingen (DE); Wolfram Baier, Ostfildern (DE); Uwe Lindemann, Holzgerlingen (DE); Peter Ludwig, Tuebingen (DE)

Correspondence Address: STRIKER, STRIKER & STENBY, 103 EAST NECK ROAD, HUNTINGTON, NY, 11743, US

(21) Appl. No.: 11/247,863

(22) Filed: Oct. 11, 2005

(30) Foreign Application Priority Data
Oct. 13, 2004 (DE) 10 2004 049 912.8

(51) Int. Cl. F16G 13/02; F16G 1/28; F16G 5/20

(52) U.S. Cl. 474/206; 474/236; 474/901; 474/202

(57) ABSTRACT

A link chain has a plurality of chain links, with at least one chain link having a carrying unit and a guide unit, wherein a carrying surface of the carrying unit, at least in places, extends in both a feed direction and in a transverse direction of the at least one chain link, and the guide unit is situated on a side of the carrying unit oriented away from the carrying surface in a vertical direction of the at least one chain link and serves to connect the at least one chain link to a chain link preceding and to a chain link following the at least one chain link in the feed direction, wherein the carrying unit is stepped with an upper plate part that has the carrying surface and a lower plate part that is offset from the upper plate part in the feed direction, wherein the lower plate part has an upper surface oriented toward a lower counterpart surface of the upper plate part of an adjoining chain link, and the upper surface of the lower plate part is at least partially inclined downwards in a direction extending from a free edge of the lower plate part toward the upper plate part.

### BACKGROUND OF THE INVENTION

The present invention relates to a link chain with a multitude of chain links; at least one chain link has a carrying unit and a guide unit; the carrying unit is provided with a carrying surface for items to be conveyed, which, at least in places, extends both in the feed direction and in the transverse direction of the chain link. The guide unit is situated on the side of the carrying unit oriented away from the carrying surface in the vertical direction of the chain link and is designed to connect the chain link to a chain link preceding it in the feed direction and a chain link following it in the feed direction. The carrying unit is embodied as stepped, with an upper plate part that has the carrying surface and a lower plate part that is offset from the upper plate part in the feed direction. The lower plate part has an upper surface oriented toward a lower counterpart surface of the upper plate part of an adjoining chain link.

It should be noted that in the entire disclosure of the present invention, directional indications such as “upper”, “lower”, “upward”, “downward”, and the like relate to an orientation of the chain link in which its vertical direction, i.e. its direction extending orthogonal to both the feed direction and the transverse direction, extends essentially in the direction of the force of gravity and the surface normal of the carrying surface points away from the pull of gravity so that the carrying surface is in a position to carry items to be conveyed.

A link chain of the kind mentioned at the beginning is known, for example, from DE 101 51 863 A1. The known link chain is one that can travel in three dimensions, i.e. it is not only in a position to follow travel paths that curve upward or downward in the feed direction, in which succeeding chain links are pivoted in relation to one another around a pivot axis extending parallel to their transverse axis, but is also in a position to follow travel paths that curve to the right or left in the feed direction, in which succeeding chain links are pivoted in relation to one another around a pivot axis extending parallel to their vertical axis. This travel in three dimensions is made possible by the particular design of the guide unit of the chain links that is described in detail in DE 101 51 863 A1 and is embodied in a practically identical fashion in the guide unit of the chain links of the link chain that is the subject of the present application.

In actual practice, it has turned out that with the use of the known link chain, the curvature radius of path segments that curve upward in the feed direction, i.e. path segments in which the carrying units of succeeding chain links approach each other as they pass through the segment, is limited to a relatively large value by the contact of the carrying units of these succeeding chain links.

This disadvantage is also present to the same degree in the link chains known from the following patent applications: DE 100 40 081 A1, DE 198 56 908 A1, DE-OS 2 306 973, EP 1 019 307 B1, EP 1 148 003 A1, EP 0 355 080 B1, EP 0 527 584 B1, U.S. Pat. No. 5,346,060, U.S. Pat. No. 3,807,548, U.S. Pat. No. 6,736,259, and U.S. Pat. No. 5,027,944.

The link chains disclosed in EP 0 995 698 A1 and EP 1 078 869 B1 have a fundamentally different design. Between each pair of succeeding chain links, an intermediate link is provided, which is associated with the one respective chain link when the link chain bends around the vertical axis and is associated with the respective other chain link when the link chain bends around the transverse axis. In each of these bends, the intermediate link constitutes a rigid, integral unit together with the chain link with which it is associated. By contrast, the chain links of the link chain according to the present invention and of the link chain that defines the species are connected to one another directly and, through the particular design of the guide unit described in DE 101 51 863 A1, nevertheless permit the link chain to bend around both the transverse axis and the vertical axis.

### SUMMARY OF THE INVENTION

Accordingly, it is an object of the present invention to provide the chain which permits tight curvature radii to be achieved even when traveling through a travel path that is curved upward in the feed direction.

This object is attained according to the present invention by means of a link chain, in which the upper surface of the lower plate part is at least partially inclined downward in the direction extending from a free edge of the lower plate part toward the upper plate part, i.e. its distance from the guide unit decreases as it extends closer to the upper plate part from a free edge of the lower plate part extending essentially in the transverse direction. The embodiment of the lower plate part according to present invention provides this lower plate part with a recess into which the upper plate part of the adjacent chain link can protrude when the chain is traveling through a path segment that curves upward. This permits a greater relative pivoting angle than link chains of the prior art were able to achieve.

In addition, dirt particles that fall down between the carrying surfaces of succeeding chain links collect in the recess embodied in the lower plate part. Since the upper plate part of the adjacent chain link does not protrude or at least does not completely protrude into the recess when the link chain is moving along path segments that are straight, curve downward, or curve only slightly upward, the dirt particles remain loosely contained in the recess until they are discharged laterally from the recess, for example due to centrifugal forces, e.g. when the link chain moves along a segment of the link chain path that curves to the left or the right. In comparison to link chains of the prior art, therefore, the link chain according to the present invention is less susceptible to soiling, i.e. there is a lower risk of dirt particles permanently penetrating into the guide unit and negatively affecting the service life of the chain.

The movement of the upper plate part into the recess provided in the lower plate part and its movement out of this recess again can occur in a particularly favorable manner if the upper surface of the lower plate part and the lower counterpart surface of the upper plate part are embodied as at least partially complementary to each other. For example, the upper surface can be embodied as least partially concave.

If the upper surface of the lower plate part and the lower counterpart surface of the upper plate part of two adjacent chain links have a predetermined minimum distance from each other in the unloaded state of the link chain as it moves along a straight segment of the link chain path, then the upper plate part can engage in the recess of the lower plate part in a particularly quiet fashion since the lower counterpart surface of the upper plate part does not slide along the lower plate part as the carrying units of the two chain links approach each other due to the relative pivoting of the two chain links around a pivot axis extending essentially parallel to their transverse axes. Only when the upper plate part of the one chain link has already moved almost completely into the recess of the lower plate part of the other chain link does a contact occur between the two plate parts and this, only in the region of the free end of the upper plate part.

Since according to the present invention, the upper surface of the lower plate part is at least partially inclined downward in the direction extending from a free edge of the lower plate part toward the upper plate part, whereas the lower counterpart surface of the upper plate part preferably extends essentially parallel to a plane suspended by the feed direction and the transverse direction, the predetermined minimum distance is present, preferably in the vicinity of the free edge of the lower plate part. The predetermined minimum distance can, for example, be approximately 0.3 mm, which on the one hand, permits the above-described freedom of the two succeeding chain links to pivot in relation to each other and on the other hand, however, also permits the upper plate part of the one chain link to rest on the lower plate part of the other chain link when an item to be conveyed is resting on the carrying surface.

In order for it to be possible to assure that the regions of the upper plate parts of succeeding chain links, which regions contain the individual sections of the carrying surface, overlap one another in the transverse direction, or in other words, to assure that each point of the movement path of the link chain can be associated with at least one chain link, which has at least one section of the carrying surface that corresponds to this path point in a projection in the transverse direction, and thus to be able to permit a continuous transfer of conveyed goods from one chain link to the next, in a modification of the present invention, the upper plate part, preferably approximately in the vicinity of the transverse middle of the chain link, on the one hand has a projection, which extends over the lower plate part and lengthens the carrying surface, and on the other hand has a recess, which serves to accommodate the projection of the respective adjacent chain link. To reduce noise, it is also possible for the projection to have space all around it in the recess when traveling along a straight segment of the link chain path, whereas it at least approaches a side of the edge of the recess when traveling along a segment of the link chain path that curves around the vertical axis.

If the carrying surface of the upper plate part and the upper surface of the lower plate part are connected to each other by means of a freeform surface, then the lack of susceptibility to soiling mentioned above can be further improved through corresponding embodiment of the freeform surface. When the chain link is embodied with a projection and a recess, the freeform surface can preferably comprise two freeform partial surfaces divided in the transverse direction by the projection.

The freeform surface or at least one freeform partial surface can have two freeform surface sections that transition into each other in the feed direction, namely a first freeform surface section adjoining the upper surface and a second freeform surface section adjoining the carrying surface. If the first freeform surface section is inclined downward in the transverse direction, i.e. toward the lateral edge of the chain link, then any dirt that is present in the region of this second freeform surface section can be pushed outward through interaction with the limit edge of the free end of the upper plate part when negotiating a curve, i.e. when traveling along a path segment that curves to the right or left. For the same purpose, in addition to this or as an alternative to it, the second freeform surface section can also be embodied as more steeply inclined in the vicinity of the transverse middle of the chain link than in the vicinity of the lateral edge of the chain link.

In order to be able to also assure an overlapping, viewed in the vertical direction, of the lower plate part of the one chain link and the upper plate part of the respective other chain link when negotiating a curve, i.e. when traveling along a path segment that curves to the right or left, it is preferable if the vertically extending pivot axis of the guide unit is situated so that it is flush in the vertical direction with the limit edge of the free end of the lower plate part.

The novel features which are considered as characteristic for the present invention are set forth in particular in the appended claims the invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIGS. 1 and 2 are perspective depictions of a chain link according to the present invention, each viewed at an angle from above;

FIG. 3 is a side view of the chain link in FIGS. 1 and 2;

FIGS. 4 and 5 are side views of a link chain composed of a number of identical chain links as it travels along a path segment that is curved downward with a slight curvature (FIG. 4) and a sharp curvature (FIG. 5);

FIGS. 6 and 7 are side views of a link chain composed of a number of identical chain links as it travels along a path segment that is curved upward with a slight curvature (FIG. 6) and a sharp curvature (FIG. 7);

FIG. 8 shows a top view of a link chain moving along a straight path segment;

FIG. 9 shows a top view of a link chain moving along a path segment that curves to the left; and

FIG. 10 shows a bottom view of the link chain in FIG. 9;

### DESCRIPTION OF THE PREFERRED EMBODIMENTS

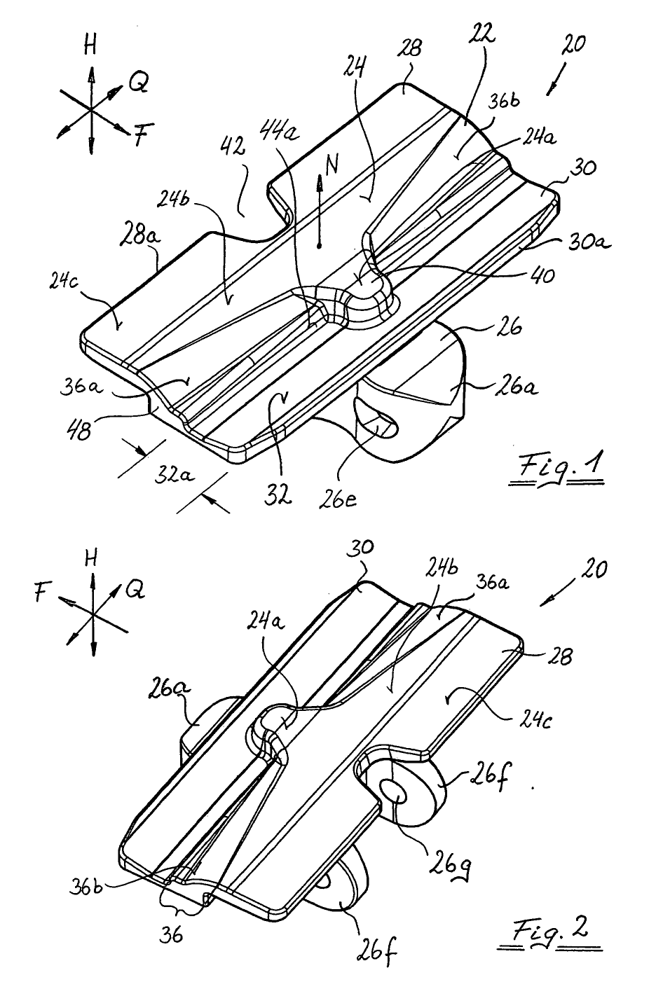

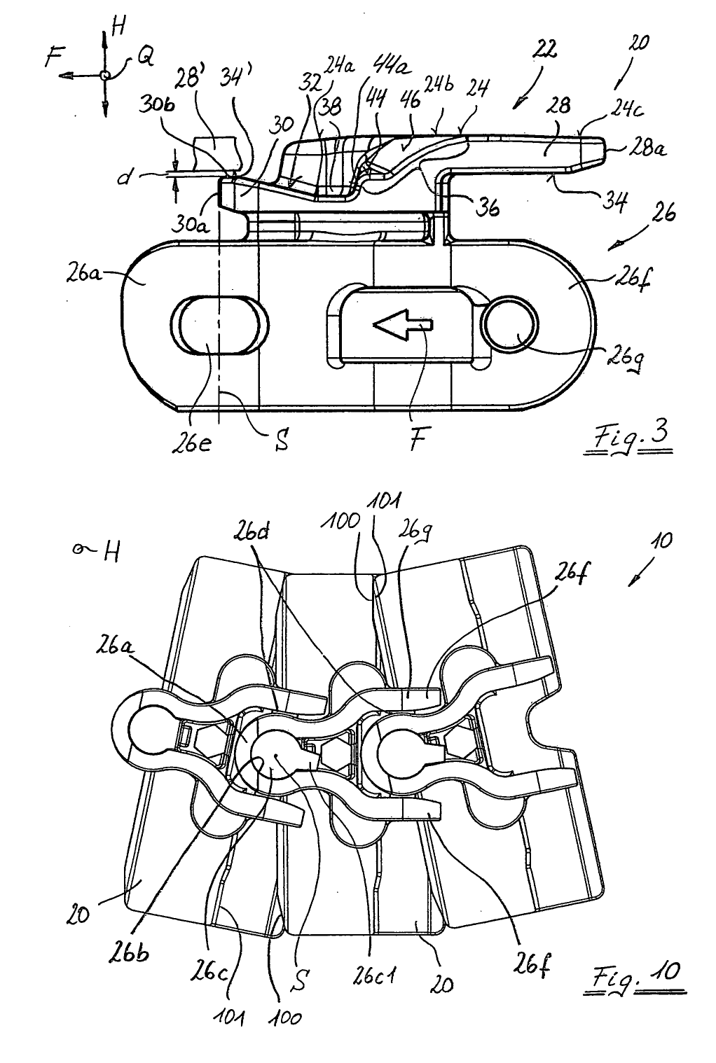

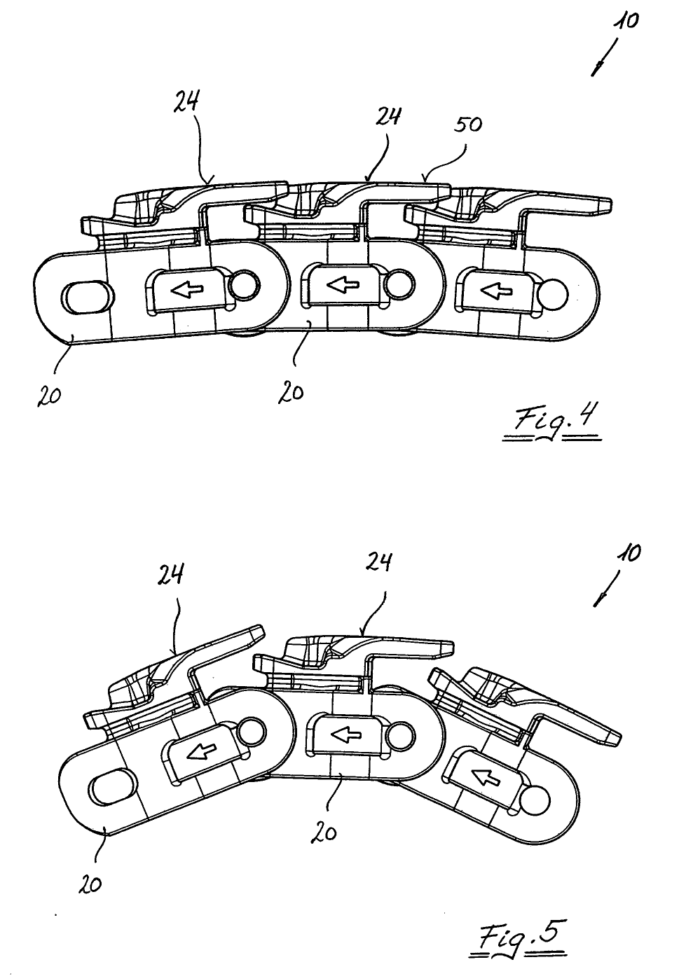

FIGS. 1 to 3 show a chain link 20 of a link chain 10, which FIGS. 4 to 10 show to be composed of a multitude of such chain links 20. The chain link 20 has a carrying unit 22 with a carrying surface 24 and a guide unit 26 situated underneath the carrying unit 22.

Whenever directional indications that relate to the chain link 20 are given herein, these directional indications relate to an orientation of the chain link 20 in which the carrying surface 24 is essentially horizontally oriented and its surface normal N points away from the direction of gravity. The directional indications also relate to a viewing direction in the feed direction F, i.e. in the movement direction of the link chain 10.

The guide unit 26 of the chain link 20 corresponds in design and function to the guide unit of the chain link described in DE 100 40 081 A1, whose description is included herein by reference as a supplement to the present disclosure. In this connection, only the following characterizing features are summarized:

An essentially cylindrical socket 26b is embodied in a head part 26a of the guide unit 26 (see FIG. 10) and its cylinder axis S extends essentially in the vertical direction H. This socket 26b contains a pivot pin 26c extending essentially in the vertical direction H, through which a pivot axle 26d passes in the transverse direction Q. The free ends of this pivot axle 26d pass through openings 26e of the head part 26a and protrude outward from it (also see FIGS. 1 to 3). The openings 26e are embodied in the form of oblong holes extending circumferentially around the pivot axis S of the pivot pin 26c. In this way, the pivot pin 26c in the socket 26b can be pivoted around its pivot axis S extending parallel to the vertical direction H by an angle that is determined on the one hand by the contact of the pivot axle 26d against the limit surfaces of the openings 26e and on the other hand, by the contact of an extension 26c1 of the pivot pin 26c against the inside of the guide unit 26.

Adjoining the head part 26a, the guide unit 26 has two legs 26f that protrude from the head part 26a in fork fashion. The spacing between the two legs 26f is selected so that the intermediate space between them can accommodate the head part 26a of an adjacent chain link 20. In addition, each of the legs 26f contains a cylindrical bore 26g extending in the transverse direction Q that serves to accommodate the free ends of the pivot axle 26d.

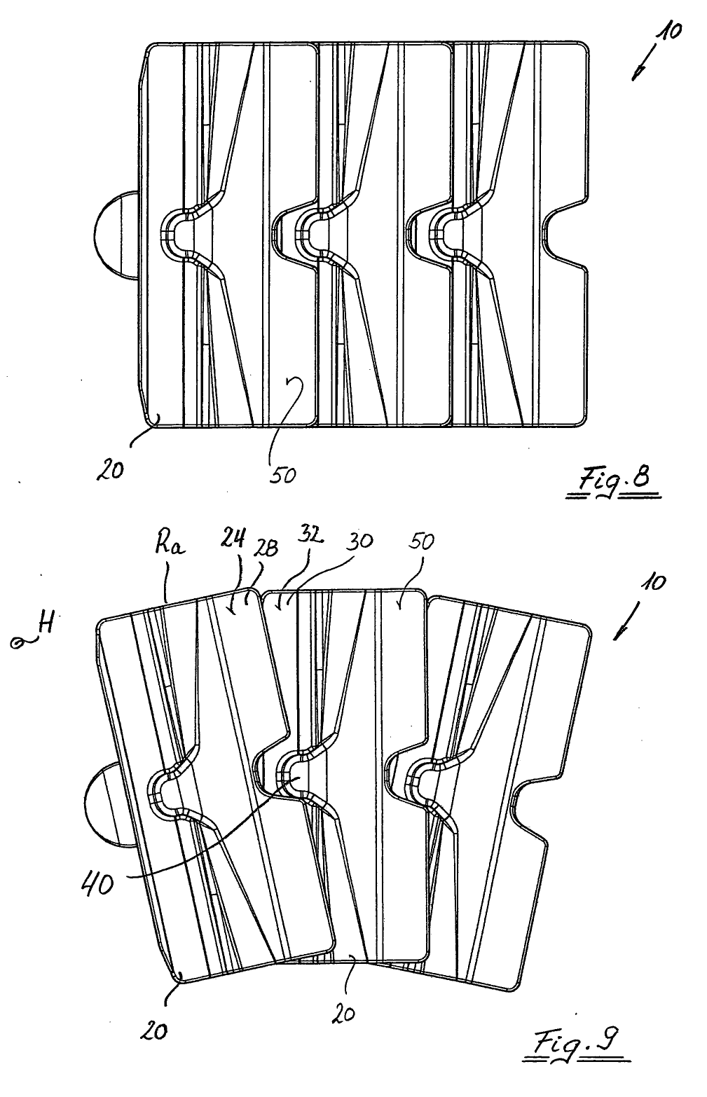

Thanks to the above-described design, two succeeding chain links 20 can be pivoted in relation to each other around the vertical axis H through the pivoting of the pivot pin 26c in the socket 26b. This makes it possible for the link chain 10 to move in the feed direction F along path segments that curve to the right or left (see FIGS. 9 and 10). On the other hand, the cooperation of the pivot axle 26d with the openings 26g of the legs 26f permits the two succeeding chain links 20 to pivot in relation to each other around an axis extending in the transverse direction Q. This permits the link chain 10 to travel in the feed direction along path segments that curve downward or upward (see FIGS. 4 and 5; and FIGS. 6 and 7).

The present invention, however, does not concern the embodiment of the guide unit 26, but rather a particular embodiment of the carrying unit 22, which permits it to follow a sharp path curvature, i.e. tight curvature radii, particularly when the link chain 10 is traveling along path segments that curve upward (see FIG. 7).

As is intrinsically known, the guide unit 22 is embodied as stepped and has an upper plate part 28 and a lower plate part 30 that is situated farther forward in the feed direction F than the upper plate part 28. On top, the carrying unit 22 has a carrying surface 24 embodied on the upper plate part 28 and designed to carry items to be conveyed by means of the link chain 10. In addition, the top of the lower plate part 30 is embodied with an upper surface 32 that is oriented toward a lower counterpart surface 34 of the upper plate part 28. The transition between the carrying surface 24 and the upper surface 32 is constituted by a freeform surface 36 (see FIG. 3), the design of which will be discussed in greater detail below.

According to the present invention, the upper surface 32 is inclined downward as it extends from a free end 30a of the lower plate part 30 at the front in the feed direction F toward the freeform surface 36 so that a recess 38 is formed in the lower plate part 30, which recess 38 serves to accommodate the upper plate part 28 of the adjacent chain link 20 when the link chain 10 moves along a path segment that curves upward (also see FIG. 3). The provision of this recess 38 permits there to be significantly tighter curves, i.e. significantly smaller curvature radii in the travel path of the link chain 10 in comparison to a link chain of the prior art in which the surface of the lower plate part 30 extends at the level of the highest point of 30b of the lower plate part 30, essentially parallel to a plane suspended by the transverse direction Q and the feed direction F (also see FIG. 7).

If the upper plate part 28 has moved almost all the way into the recess 38, then its contact surface 28a comes into contact with a counterpart contact surface 44a of the lower plate part 30. According to the present invention, however, at least in the unloaded state of the link chain 10, no contact occurs between the upper surface 32 of the lower plate part 30 and the lower counterpart surface 34 of the upper plate part 28, which in turn contributes to a reduction in the generation of noise.

The recess 38 also has the advantage during normal, straight travel in the feed direction F and with travel paths that curve slightly upward or downward (see FIGS. 4 to 6), of being able to catch dirt particles that travel downward from the carrying surface 24 via the freeform surface 36 and into this recess 38, where they cannot hinder the actual function of the link chain 10, namely the conveyance of items placed onto the conveying surface 24. When the link chain 10 moves along a path segment that curves to the right or left (see FIGS. 9 and 10), the dirt particles can then be discharged laterally from the recess 38.

As is shown in FIG. 3, the upper surface 32 is concavely curved and, as is particularly clear from FIG. 7, is essentially complementary to the curvature of the lower counterpart surface 34 of the upper plate part 28. FIG. 3 also shows that in the unloaded state of the chain links 20, the lower counterpart surface 34′ of the adjacent chain link 28′ is spaced apart from the upper surface 32 of the lower plate part 30 by a minimum distance d that can be on the order of 0.3 mm. This minimum distance d improves the quietness of operation of the unloaded link chain 10. The minimum distance d is nevertheless selected to be sufficiently small to permit the upper plate part 28′, when loaded with an item to be conveyed, to rest on the lower plate part 30 in the region of its highest point 30b in order to thus assure a uniform load absorption by the entire link chain 10.

In order to be able to assure a uniform support of the items to be conveyed over the entire length of the link chain 10, according to the present invention, the upper plate part 28 is also provided with a projection 40 that protrudes in the direction of the free end 30a of the lower plate part 30, into the length segment 32a associated with the upper surface 32 (see FIG. 1). In addition, the free end 28a of the upper plate part 28 contains a recess 42 that corresponds to the projection 40 and serves to accommodate the projection 40 of the adjacent chain link 20. In this way, viewed in the transverse direction Q, it is possible for the carrying surfaces 24 of succeeding chain links 20 to overlap, which yields an overall carrying surface 50 of the link chain 10 that is essentially closed in the feed direction F.

In the link chain 10 according to the present invention, this closed nature is even assured, as shown in FIG. 4, when the link chain is traveling along a path segment that curves slightly downward. Only with a path of the link chain 10 that curves more sharply downward does the overall carrying surface 50 open up so that visible gaps form between the carrying surfaces 24 of the individual chain links 20 in the transverse direction Q (see FIG. 5).

In order to provide symmetrical conditions for negotiating curves to the left and the right in the feed direction F, the projection 40 and the recess 42 are situated essentially in the vicinity of the transverse middle of the chain link 20. For specific applications in which the link chain 10 travels through path segments that curve essentially in only one direction within the operationally significant segment of their path of travel, i.e. the segment in which they must perform their function of conveying items, then it is also conceivable for the projection 40 and the recess 42 to be situated off-center in terms of the transverse span of the chain link 20.

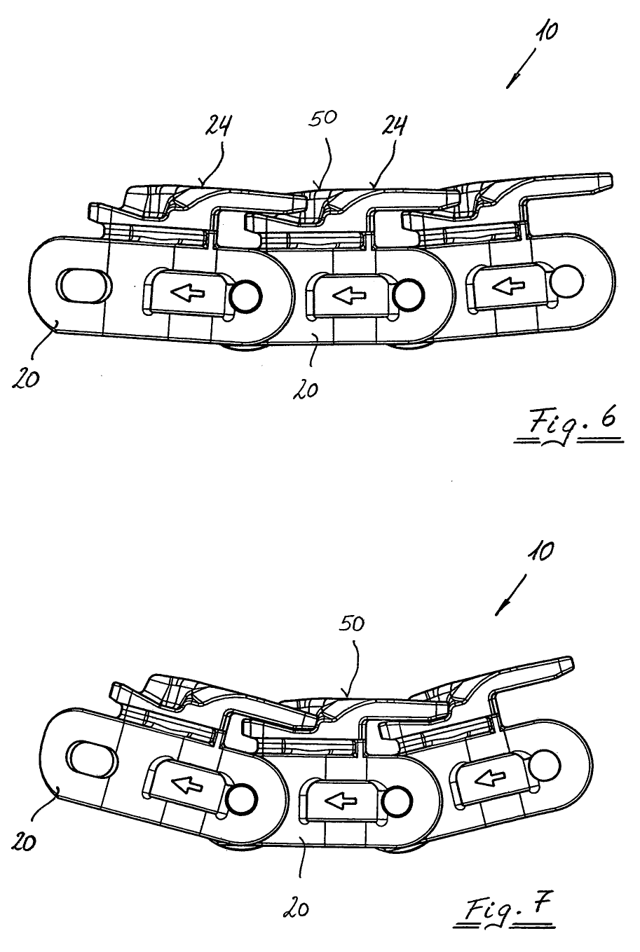

As is shown in FIG. 8, the projection 40 of the one chain link 20 in a pair of adjacent chain links does in fact protrude far enough into the recess 42 of the respective other chain link 20 to produce the above-described overlap in the transverse direction Q. However, in the straight travel shown in FIG. 8, the projection 40 does not come into contact with the limit edge of the recess 42, but is spaced apart from it on all sides. In the curved travel shown in FIGS. 9 and 10, the projection 40 is spaced a predetermined distance apart from the lateral edge of the recess 42 since the minimum curvature radius has already been established by the interaction of the contact surfaces 100 and 101.

FIG. 9 also shows that the span of the lower plate part 30 in the feed direction F is dimensioned so that when negotiating a curve, the link chain 10 also essentially does not open at its outer edge Rₐ, but instead, the carrying surface 24 of one of two succeeding chain links 20 overlaps the upper surface 32 of the respective other chain link 20 in the vertical direction H.

The freeform surface 36, or more precisely stated, each of two freeform surface sections 36a and 36b divided by the projection 40, is composed of two partial surfaces, namely a first partial surface 44 adjoining the upper surface 32 and a second partial surface 46 adjoining the carrying surface 24. According to the present invention, the first partial surface 44 is inclined downward from the projection 40 to the lateral edge 48 of the chain link 20. Due to this embodiment of the first partial surface 44 such that it slopes downward toward the outside, dirt particles that travel from the carrying surface 24 via the second freeform partial surface 46 into the region of the first freeform partial surface 44 can be discharged laterally from the link chain 10 through the interaction of the trailing edge of the free end 28a of the upper plate part 28 with the first partial surface 44 as a result of the link chain 10 traveling along a path segment that curves to the right or left in the feed direction. The link chain 10 according to the present invention is therefore practically self-cleaning. This makes it possible for dirt particles resting loosely on the surface to be easily swept off, while dirt particles adhering to the first partial surface 44 and the second partial surface 46 are scraped off from them by the above-described engagement between the free end 28a of the upper plate part and the freeform surface 36 and only then are these dirt particles swept off.

It should also be noted that the carrying surface 24 does not necessarily have to extend completely parallel to a plane suspended by the feed direction F and the transverse direction Q. There can also be slight deviations of up to 5° from a strictly parallel orientation, as indicated in FIGS. 1 to 3 by the partial surfaces 24a, 24b, and 24c of the carrying surface 24.

It should also be noted that the pivot axis S of the guide unit 26, as shown in FIG. 3, is situated flush in the vertical direction H with the limit edge 30a of the surface 30b at the free end of the lower plate part 30.

It will be understood that each of the elements described above, or two or more together, may also find a useful application in other types of constructions differing from the types described above.

While the invention has been illustrated and described as embodied in a link chain, it is not intended to be limited to the details shown, since various modifications and structural changes may be made without departing in any way from the spirit of the present invention.

Without further analysis, the foregoing will reveal fully revela the gist of the present invention that others can, by applying current knowledge, readily adapt it for various applications without omitting features that, from the standpoint of prior art, fairly constitute essential characteristics of the generic or specific aspects of the invention.

What is claimed as new and desired to be protected by Letters Patent is set forth in the appended claims:

1. A link chain, comprising a plurality of chain links, with at least one chain link having a carrying unit and a guide unit, said carrying unit being provided with a carrying surface for items to be conveyed, said carrying surface of said carrying unit, at least in places, extending in both a feed direction and in a transverse direction of said at least one chain link, said guide unit being situated on a side of said carrying unit oriented away from said carrying surface in a vertical direction of said at least one chain link and serves to connect said at least one chain link to a chain link preceding said at least one chain link in the feed direction and to a chain link following said at least one chain link in the feed direction, said carrying unit being configured as stepped with an upper plate part that has said carrying surface and a lower plate part that is offset from said upper plate part in the feed direction, said lower plate part having an upper surface oriented toward a lower counterpart surface of said upper plate part of an adjoining chain link, said upper surface of said lower plate part being at least partially inclined downwards in a direction extending from a free edge of said lower plate part toward said upper plate part.

2. A link chain as defined in claim 1, wherein said upper surface of said lower plate part and said lower counters part surface of said upper plate part are at least partially configured as complimentary to each other.

3. A link chain as defined in claim 1, wherein said upper surface of said lower plate part is configured at least partially concave.

4. A link chain as defined in claim 1, wherein said upper surface of said lower plate part and said lower counterpart surface of said upper plate of two adjacent ones of said chain links had a predetermined minimum distance from each other in an unloaded state of the link chain as it moves along a straight segment of a path of the link chain.

5. A link chain as defined in claim 1, wherein said upper plate part has at least one projection which extends over said lower plate part and lengthens said carrying surface and also has at least one recess which serves to accommodate said projection of a respective adjacent one of said chain links.

6. A link chain as defined in claim 5, wherein said upper plate part is provided with said at least one projection approximately in a vicinity of a transverse middle of said chain link and constitutes precisely one projection, while said at least one recess constitutes precisely one recess.

7. A link chain as defined in claim 5, wherein said projection has a space all around it in said recess when traveling along a straight segment of a path of the link chain, whereas it at least approaches a side of an edge of said recess when traveling along a segment of the path of the link chain that is curved around a vertical axis.

8. A link chain as defined in claim 1, wherein said carrying surface of said upper plate part and said upper surface of said lower plate part are connected to each other by a freeform surface.

9. A link chain as defined in claim 8, wherein said at least one chain link is configured with a projection and a recess, said freeform surface comprising two freeform partial surfaces divided in the transverse direction by said projection.

10. A link chain as defined in claim 8, wherein said freeform surface has two freeform surface sections that transition into each other in the feed direction, and include a first freeform surface section adjoining said upper surface and a section freeform surface section adjoining said carrying surface.

11. A link chain as defined in claim 10, wherein said first freeform surface section is inclined downwards as it extends toward a lateral edge of said at least one chain link.

12. A link chain as defined in claim 10, wherein said second freeform surface section is configured as more steeply inclined in a vicinity of a transverse middle of said at least one chain link than in a vicinity of a lateral edge of said at least one chain link.

13. A link chain as defined in claim 8, wherein said at least one chain link is configured with a projection and a recess, said freeform surface comprising at least one freeform partial surface divided in the transverse direction by said projection.

14. A link chain as defined in claim 13, wherein said first freeform surface section is inclined downwards as it extends toward a lateral edge of said at least one chain link.

15. A link chain as defined in claim 13, wherein said second freeform surface section is configured as more steeply inclined in a vicinity of a transverse middle of said at least one chain link than in a vicinity of a lateral edge of said at least one chain link.

16. A link chain as defined in claim 1, wherein said guide unit has a pivot axis situated so that said pivot axis is flush in the vertical direction with a limit edge of a surface at a free end of said lower plate part.
